(19) United States
(12) Patent Application Publication
(10) Pub. No.: US 2015/0135997 A1
(43) Pub. Date: May 21, 2015

(54) INTERNAL CURING COMPOSITION FOR CONCRETE MIXTURES

(71) Applicant: THE CURATORS OF THE UNIVERSITY OF MISSOURI, Kansas City, MO (US)

(72) Inventor: John T. Kevern, Kansas City, MO (US)

(21) Appl. No.: 14/402,960

(22) PCT Filed: May 22, 2013
(86) PCT No.: PCT/US13/42287

§ 371 Date: Nov. 21, 2014

Related U.S. Application Data
(60) Provisional application No. 61/650,139, filed on May 22, 2012.

(51) Int. Cl. C04B 28/04

(52) U.S. Cl. CPC C04B 28/04
USPC 106/709; 106/737; 106/714

(57) ABSTRACT

A cementitious mixture including drinking water treatment waste (DWTW) solids, an aggregate, cement and water exhibits improved cement hydration, compressive strength and mitigated autogenous shrinkage. DWTW solids provide an internal curing agent for use with a cementitious mixture. DWTW solids are produced by a water treatment process of flocculating water to produce floc having entrained water, allowing the floc to settle out and dewatering the floc to produce DWTW solids. The DWTW solids form up to about 200 pounds per cubic yard of the cementitious mixture. The DWTW solids have a moisture content of about 5% to about 55% and a particle size of about 10 μm to 150 μm. The cementitious mixture may be cured to form concrete structural elements and products and masonry products. A method of using DWTW solids as an internal curing agent for cementitious mixtures produces cured concrete compositions having improved compressive strength and reduced autogenous shrinkage.

### CROSS REFERENCE TO RELATED APPLICATION

This application claims priority under 35 U.S.C. 119(e) and 37 C.F.R. 1.78(a)(4) based upon copending U.S. Provisional Application Ser. No. 61/650,139 for INTERNAL CURING COMPOSITION FOR CONCRETE MIXTURES filed May 22, 2012, the entirety of which is incorporated herein by reference.

### FIELD

The present disclosure is generally related to compositions and methods for internal curing of concrete mixtures. More particularly, it concerns compositions and methods that use flocculated solids from water treatment facilities as an internal curing agent for concrete mixtures.

### BACKGROUND

Concrete is a mixture generally comprised of aggregate, cement or binder, and water. The proportions are variable, and one or more chemical additives may also be incorporated into the mixture to impart desired properties. The aggregate is generally a mixture of gravel or crushed rocks and sand. Various forms of cement may be used as a binder, with Portland cement being most common, often in combination with other cementitious material such as fly ash and slag cement. There are many blends or types of Portland cement, variously categorized by the ASTM standard C150, which is used mainly in the United States, and the European standard EN-197 used in Europe. Portland cement is produced by sintering limestone (CaCO₃) with smaller quantities of additional materials such as clay that contains aluminum and silicates. Other materials such as shale, sand, iron ore, bauxite, fly ash and slag may also be included in the mix. The resulting product, known as cement clinker, is ground to a powder with a small quantity of gypsum (CaSO₄.2H₂O). The addition of water to the aggregate and cement mixture forms a cementitious or concrete mixture.

Concrete sets or cures to a hardened condition through a chemical reaction process call hydration. The cement particles generally contain calcium, aluminum, silica, and some iron. When water is added, the calcium initially goes into solution. Sulfate (in the form of gypsum) is interground with the cement clinker to help control the initial aluminate reaction and provide time for transportation and placing. During transport the calcium concentration increases, raising the pH until the high pH begins to dissolve the silicates. During hydration the cement grains combine with water to form primarily calcium-silicate hydrates and calcium-aluminate-hydrates. The hydration process continues over time, converting cement grains and water to hardened hydration products. Once the mixing water is depleted and/or the internal humidity falls below 80%, hydration ceases. Thus, maintaining high internal humidity during curing is important to increase the strength of the concrete.

While the hydration process is necessary to change powdered cement and water into hard, insoluble concrete, this process is not perfect. The volume of hydrated cement and water is about 7% less than the original mixture constituents. Hydrating cement paste shrinks through several mechanisms broadly grouped into autogenous and drying shrinkage. These shrinkages cause cracks which become high permeability routes for water and aggressive ion movement, such as chlorides to reinforcing steel. Drying shrinkage can be controlled by appropriate curing methods. Once the concrete has set, the continued hydration and internal volume reduction build stresses within the hydrated cement matrix. Along with this chemical shrinkage, depletion of liquid water from the pore space between the hydrating cement grains causes vapor-filled air pockets to form within the concrete. These lower pressure pockets also place additional internal stresses on the curing concrete. The self-desiccation and chemical shrinkage from the hydration process is called autogenous shrinkage. For mixtures with water-to-cement ratios greater than 0.42, autogenous shrinkage is not-significant. However for high performance concrete with lower water-to-cement ratios, autogenous shrinkage can be severe and may cause significant internal cracking. Proper curing does little to affect autogenous shrinkage, especially in mixtures with low water-to-cement ratios. For these mixtures, even curing under water will not provide sufficient moisture, since the permeability of the mixture is too low to allow the moisture to penetrate beyond a few millimeters below the surface.

As the concrete industry strives to become more environmentally friendly, a key aspect is improving durability. Good durability for concrete and reinforced concrete structures requires that the cured concrete have low permeability and minimal cracking so that ingress of unwanted water and chemicals is prevented. Two of the most common techniques employed to reduce permeability and improve durability are lowering water-to-cement ratios and including supplementary cementitious materials, such as fly ash and silica fume. However, both of these techniques cause increased autogenous shrinkage. Providing an internal supply of additional water, not part of the original mixing water, on an as-needed basis to the hydrating cement, reduces autogenous shrinkage and allows for more complete hydration. This increased hydration reduces autogenous shrinkage, minimizes total shrinkage and cracking and protects against cracking-related corrosion of concrete reinforcement members. More complete hydration creates a denser cement paste, reducing permeabililty and improving durability and longevity of the cured concrete. The National Institute for Standards and Technology (NIST) has stated that “it appears that internal curing has the potential to make a substantial impact on the durability and lifecycle costs of concrete structures.”

To help reduce the internal stresses which develop in low permeability, high performance concretes, the concrete industry has begun using internal curing compositions or agents. These agents are particularly beneficial for cement mixtures having a water to cement ratio of less than about 0.43, mixtures which are generally classified as “high performance” cement mixtures. However, internal curing may also be used for any other cementitious products. The two most common materials used for internal curing include pre-wetted lightweight aggregates and super absorbent polymers which may be added to the fresh concrete mixture. The pore sizes or spaces in the high porosity aggregates are larger than the pore spaces in the concrete. During the hydration process, the moisture stored in the aggregates or polymers is drawn from the pores into the hydrating concrete. This extra water reduces the amount of vapor-filled pores by maintaining a higher internal relative humidity. This creates a denser cement paste with lower permeability by increasing the amount of hydration that occurs.

Currently, pre-wetted high porosity aggregates are most often used as internal curing agents. These aggregates are typically manufactured from a high absorption and porous material such as expanded slate, shale, and/or clay through a high temperature rotary kiln process. After the material is expanded in the kiln, saturation must occur before the material can be used in concrete. Various saturation methods are employed by different manufacturers. Saturation may be achieved by soaking the aggregate for a predetermined amount of time. Alternatively, a vacuum saturation process may be employed. The manufactured high porosity aggregates include lightweight coarse aggregate measuring greater than about 0.25 inches and lightweight fine aggregate measuring less than about 0.25 inches.

For internal curing purposes, pre-wetted lightweight fine aggregates have shown more benefit than courser materials because of the better distribution of moisture achievable within the large number of fine particles. Moisture in the lightweight aggregate is physically held by capillary force. The best internal curing is generally produced by substituting saturated lightweight fine aggregate for a portion of typical fine aggregate, such as sand. The small particles become uniformly dispersed in the cement matrix and provide improved curing to a majority of the cement paste. While these saturated aggregates are volume stable and contribute to concrete strength, the degree of saturation in lightweight aggregate and moisture management can be problematic. Dry or under-saturated lightweight aggregate may take up water from the mixture and affect workability of the concrete paste.

Super absorbent polymers (SAPs) are typically crystalline salts, which are known to form hydrogels on contact with water. These polymers can expand to absorb thousands of times their dry weight in water without dissolving, although commercially available SAPs generally exhibit absorbency below 20 g/g. They are used in many industries, notably to form the absorbent gel in disposable diapers. Super absorbent polymers have also been used in the cement industry to entrain water, although the high pH, or alkaline, environment of the concrete mixture substantially reduces the extent of SAP absorption compared to pure water. While water stored in the internal pores of pre-wetted lightweight aggregates does not affect workability of the concrete mixture, the absorption and swelling of super absorbent polymers will affect workability. The swelling of the polymer can act as a viscosity modifier and may result in slight water reduction. When mixed into fresh concrete paste, super absorbent polymers absorb water and swell. Alternatively, they may be pre-wetted and mixed into the concrete paste. The superabsorbent polymer absorbs water and serves as a bulk water reservoir during hydration. During curing, the entrained water is released once the internal humidity falls below a critical level, and the desorbed polymer gels shrink and become inert, leaving behind pores in the paste structure. Polymers having higher absorption ratios are known to insert larger numbers of pores. These pores reduce the overall density of the concrete as well as its compressive strength. Thus, while super absorbent polymers are effective to reduce autogenous shrinkage and early age cracking of concrete, this comes at the cost of reduction in concrete strength. Such reduction in compressive strength is particularly undesirable for high performance applications. In addition, the use of super absorbent polymers adds to the cost of concrete production.

Thus, there is a need for an internal curing agent for concrete that will maintain a high moisture content in the concrete as it cures, thereby increasing the curing speed as well as the strength of the cured product, without forming pores that diminish the compressive strength, and that will also be cost-efficient.

A majority of the US population obtains its drinking water from surface waters. Water treatment processes, in particular, so-called drinking water treatment processes, produce large amounts of high calcium waste solids or sludge (DWTW) from flocculation and filtration of such surface waters. The average American uses about 80-100 gallons (0.3-0.37 m³) of water each day, which produces about 4% sludge generated as a total of water treated. Dumping of DWTW sludge back into surface waters of the United States is prohibited by the Clean Water Act, 33 U.S.C. §1251 et seq. Sludge handling is responsible for about 30% to 40% of the capital cost of a water treatment plant, and about 50% of the operating costs of the plant. Settled sludge particles are dewatered into a semi-dry cake, having about 50% solids, before disposal. In 2010, the U.S. produced 7 million metric tons of lime sludge from drinking water treatment (on a dry solid basis).

Although classified as wastes, analysis of these solids has shown them to comprise benign, non-hazardous materials. In recognition of this fact, the U.S. Environmental Protection Agency (EPA) and most state agricultural departments have adopted guidelines for land application disposal of the solids. Costly natural gas drying is generally required before land application disposal as agricultural lime. Most of the solids are deposited in local landfills or open pits. Unfortunately, fewer permits are being issued for new landfills and tipping fees for landfill deposits have increased accordingly. Disposal of drinking water treatment solids can be a significant contributor to the cost of municipal water plant operation. These increases in the cost of disposal exert continuing upward pressure on the cost of drinking water production.

Consequently, there have been numerous investigations directed toward discovery of beneficial uses for drinking water treatment solids. Most of these studies have been focused on the potential for use of the solids as a lime depletion replacement in agriculture, or for soil stabilization purposes. However, the high water content of the solids and their low economic value generally makes transportation costs prohibitive for these kinds of applications.

Particles in the solid sludge are seldom dispersed during the water treatment process, and instead form into agglomerations called flocs. The water contained in the sludge falls into two categories, bulk water and bond water. Bulk water can be drained and removed relatively easily compared with bond water. Bond water includes interstitial water, vicinial water, and water of hydration. Interstitial water is water trapped in the interstitial spaces of the flocs, and it can become free water if the structure of the flocs is destroyed. Vicinial water comprises multiple layers of water molecules held to the particle surfaces through hydrogen bonding. Water of hydration is water that is chemically bound to the particles, and removable only by thermal drying. Bond water is the most easily accessible of the characteristic waters contained in drinking water treatment waste.

Thus, there is a need for a use for drinking water treatment solids that will recycle large quantities of these materials at a location near to the drinking water treatment plant, thereby minimizing transportation costs, and preferably without the need for additional expenditures for drying.

### SUMMARY

The present disclosure provides a greatly improved method for internal curing of concrete compositions that uses solids from water treatment processing to increase both hydration levels during curing and the strength of the cured concrete product. The disclosure also provides a novel internal curing agent for concrete mixtures. The disclosure further provides a cementitious mix comprising an aggregate, cement, water, and an internal curing composition including a quantity of water treatment waste solids. The solids are dewatered to have a moisture content of from about 40% to about 55% and a particle size of about 10 μm to about 150 μm. In one aspect, a cementitious or concrete mix is provided including solids from drinking water treatment processing. In another aspect, a method of preparing an internally curing cementitious or concrete mix includes combining cement and aggregate with solids from drinking water treatment processing in an amount sufficient to enable a paste prepared from the mix to cure. In still another aspect, a concrete product is formed from an internal curing cementitious mix comprising an aggregate, cement, water and a quantity of drinking water treatment waste solids. In still another aspect, a masonry product is formed that includes an amount of the drinking water treatment waste solids that act as internal curing agents.

Various objects and advantages of this disclosure will become apparent from the following description taken in conjunction with the accompanying drawings wherein are set forth, by way of illustration and example, certain embodiments of this method for internal concrete curing and a cementitious mix incorporating the internal curing agent. The drawings constitute a part of this specification, include exemplary embodiments, and illustrate various objects and features thereof.

### BRIEF DESCRIPTION OF THE DRAWINGS

FIG. 1 is a graphic representation showing the internal water needed to maintain saturated conditions in cement paste;

FIG. 2 is a graphic representation showing the effect on hydration of control mortar cured at various relative humidities;

FIG. 3 is a graphic representation showing the effect on hydration of various mortars of addition of additional curing water at 5 lbs/100 lbs cement;

FIG. 4 is a graphic representation showing the effect on hydration of various mortars caused by 50% volume replacement of standard sand with various internal curing agents under various hydration conditions during curing;

FIG. 5 is a SEM Micrograph taken at 150× (low magnification) showing a range of particle sizes and porous surface;

FIG. 6 is a SEM Micrograph similar to that shown in FIG. 5 taken at 600× (higher magnification) showing particles sized from about 10 μm to about 100 μm and porous structure;

FIG. 7 is a SEM Micrograph taken at 3000× (high magnification) showing open structure with flocculated calcium carbonate particles;

FIG. 8 is a SEM Micrograph taken at 5000× (high magnification) showing a small 10 μm particle, characterized as a conglomeration;

FIG. 9 is a tabular representation of the X-Ray Florescence profile of DWTW obtained at Kansas City, Mo., showing typical chemistry for lime-softened drinking water;

FIG. 10 is an X-Ray Diffraction plot for drinking water treatment waste solids from Kansas City, Mo.;

FIG. 11 is a graphic representation of the effect of addition of drinking water treatment waste solids on concrete drying shrinkage and autogenous shrinkage;

FIG. 12 is a tabular summary of the composition of mortar mixtures used in Example 1;

FIG. 13 is a graphic representation showing the measured compressive strength for mortars in accordance with Example 1 cured under 100% relative humidity;

FIG. 14 is a graphic representation showing the measured compressive strength for mortars in accordance with Example 1 cured under sealed conditions;

FIG. 15 is a graphic representation showing the comparative degree of hydration of mortars in accordance with Example 1 cured at 50% relative humidity;

FIG. 16 is a graphic representation showing the comparative degree of hydration of mortars in accordance with Example 1 cured under different relative humidities at 28 days;

FIG. 17 is a graphic representation of measured total shrinkage of unsealed prism mortars in accordance with Example 1 with different internal curing agents;

FIG. 18 is a graphic representation of calculated mass change of unsealed prism mortars in accordance with Example 1 with different internal curing agents;

FIG. 19 is a graphic representation of measured deformation of autogenous shrinkage of sealed prism mortars in accordance with Example 1;

FIG. 20 is a graphic representation of calculated drying shrinkage of sealed prism mortars in accordance with Example 1; and

FIGS. 21A-E show SEM Micrographs of mortars prepared with different internal curing agents in accordance with Example 1 at 7 days under sealed curing conditions.

### DETAILED DESCRIPTION

A method for internal curing of concrete compositions includes providing quantities of drinking water treatment waste solids, coarse and fine aggregate, cement and water. Quantities of the coarse aggregate and water are mixed. During continued mixing, quantities of fine aggregate, cement and drinking water treatment waste solids are added. Additional quantities of water may be added and the mixture is cured to form concrete articles, structural elements and products and masonry elements and products.

The water treatment waste solids are a high calcium waste material by-product of water that is treated for various uses, including, but not limited to, human consumption. While these solids may be obtained from any suitable water source, drinking water treatment is a particularly abundant source of waste solids. A majority of the U.S. population uses surface waters for drinking, although these waters typically require more treatment for potability than ground waters. The drinking water treatment waste solids described herein are not limited to solids obtained from treatment of surface waters. They may also be obtained from treatment of ground water or any other suitable water source for the production of potable water. In the United States, the Safe Drinking Water Act, 42 U.S.C. §300 et seq., is the principal law regarding allowable drinking water quality. National standards for drinking water quality are established and monitored by the U.S. Environmental Protection Agency. Some common treatment processes include solids separation by settling and filtration and chemical treatments such as disinfection and coagulation. The water may be subject to prechlorination to arrest biological growth and for algae control and disinfection to kill bacteria. It may also be aerated to remove dissolved iron and manganese and coagulated to achieve flocculation. Polyelectrolytes may be added to improve coagulation and cause thicker flakes or flocs, followed by sedimentation to separate any suspended solids trapped in the floc. Individual localities use water treatment protocols that may include an appropriate combination of some or all of these processes, based on the available water source, the season and any other relevant factors.

Water treatment processes, including surface and ground water treatment, in accordance with the Safe Drinking Water Act and EPA regulations are described in Water Quality and Treatment, 6th Ed., by James K. Edzwald, New York:McGraw-Hill (2011) and other environmental engineering references. The drinking water treatment waste described herein may be produced by any such process in current practice or as subsequently modified. In a typical surface water treatment process, calcium hydroxide, Ca(OH₂) and inorganic flocculants or coagulants, such as aluminum sulfate or alum, and/or iron III salts, such as iron chloride, and/or magnesium, are added to settle out colloids in the raw water, along with any silica or sand. If excess hardness is present in the water in the form of Ca2⁺ or Mg2⁺, then calcium carbonate may be added again to create calcium and magnesium carbonates which settle out. The water may be subsequently filtered to remove any remaining particles, and chlorine and/or ozone may be used to disinfect the water before distribution. The colloid particles or solids come out of suspension in the form of floc or flake. These settled particles or solids are commonly known as sludge, and may be subject to further dewatering before disposal. The quantity of solids produced by treatment varies depending on the quality of the water source. In general, approximately about 4% or more of the total water subject to a drinking water treatment process is collected as waste solids. Any water treatment waste solids produced from water treatment processes that produce drinking water or water for any other consumer use can be used as an internal curing agent for concrete mixtures for producing concrete and masonry products.

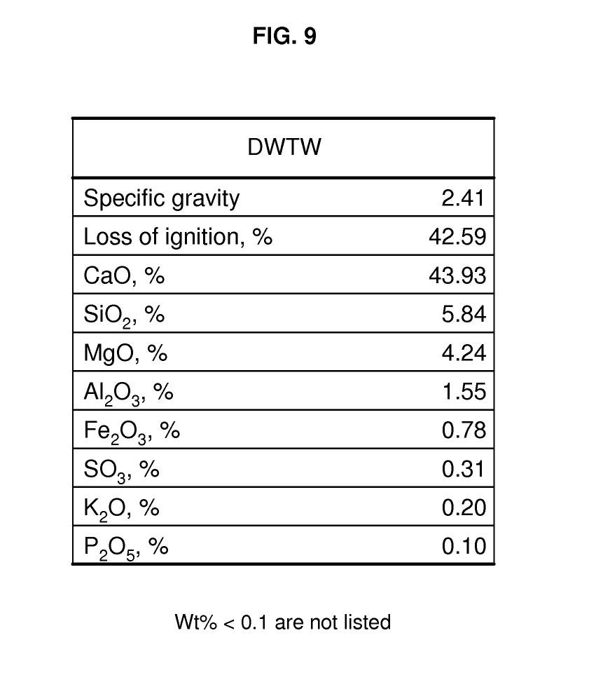

FIG. 9 shows the typical chemistry of drinking water treatment waste from lime-softened drinking water taken from the Kansas City, Mo. Water Plant as determined by X-Ray Florescence. Trace amounts of Na₂O, Sc₂O₃, TiO₂, V₂O₅, Cr₂O₃, MnO, F and SrO were also present at weight percentages of less than 0.1%. Those skilled in the art will appreciate that the chemical composition of the source water will be different for every source, every season and every water level during the calendar year. In addition, variances in acceptable treatment methods may occur. Thus, drinking water treatment wastes may produce X-Ray Florescence profiles that differ somewhat from that shown in FIG. 9. Following treatment, the waste solids consist primarily of calcium carbonate, CaCO₃, as well as varying amounts of the elements and compounds listed in FIG. 9. It is foreseen that the most economically favorable practice of the disclosed method and composition may involve use of locally obtained drinking water treatment waste solids. Such locally obtained solids may include some or all of the elements and compounds listed in FIG. 9 as well as additional elements and/or compounds which may be found in waste solids at drinking water treatment plants at other geographic locations. It is also foreseen that calcium carbonate, as well as each element or compound may be present in the waste solids in a concentration of from about 0% to about 100%.

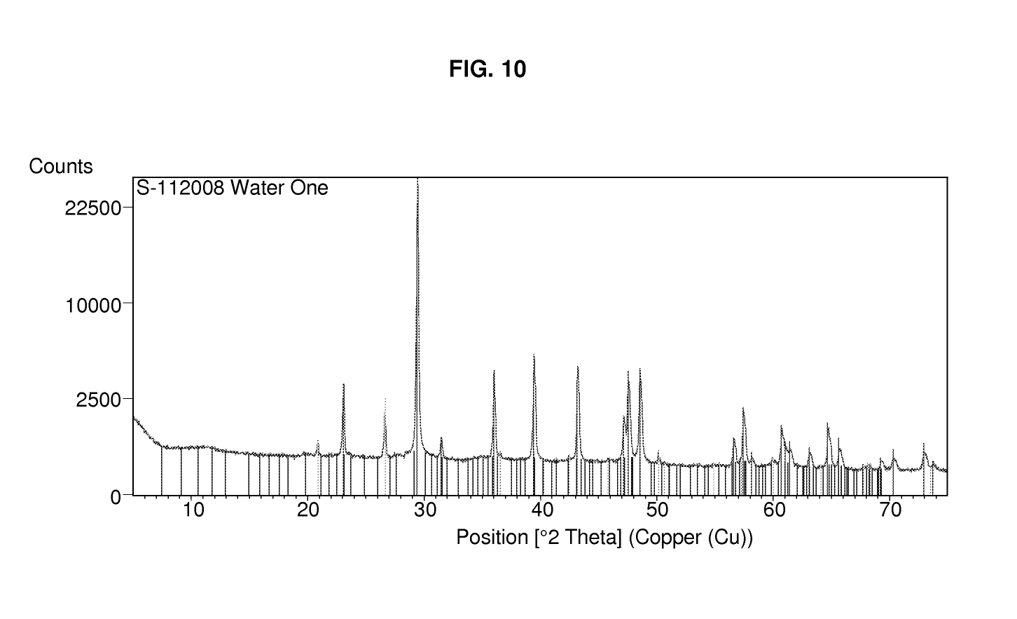

FIG. 10 shows the X-Ray diffraction profile of a sample of drinking water treatment waste solids taken from the Kansas City, Mo. water plant. The profile shows the primary crystalline components of the sample to be calcium carbonate, quartz and magnetite. The attraction of water to the calcium causes the solids to retain a high moisture content even after dewatering. It is foreseen that drinking water treatment waste solids will act as an internal curing agent even in the absence of one or all of silica, magnesium and alumina.

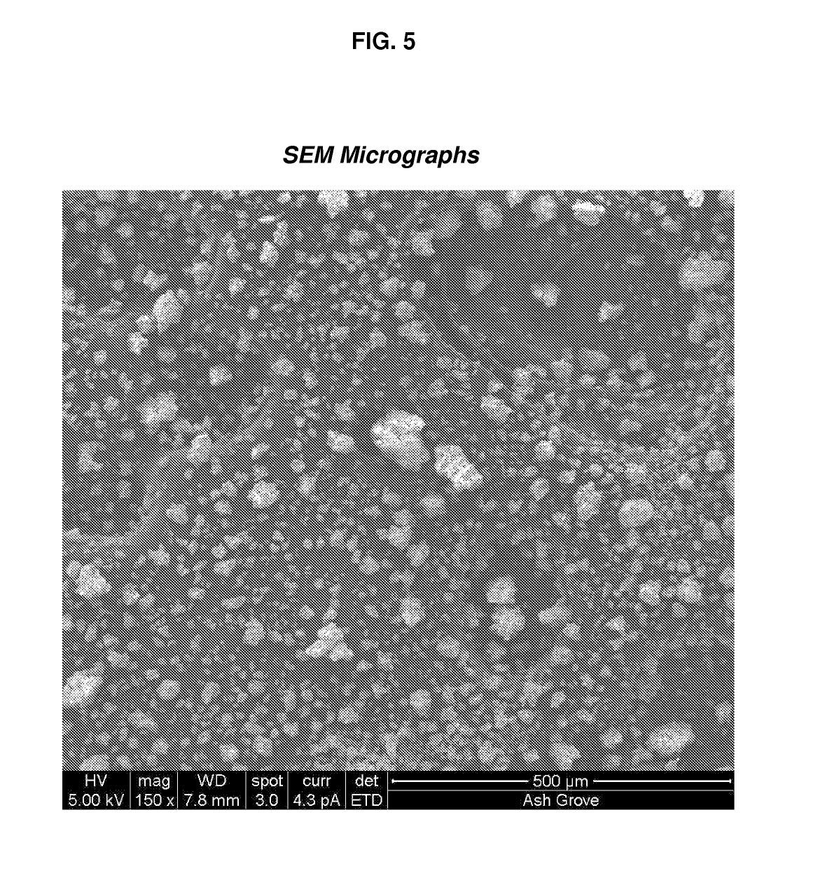

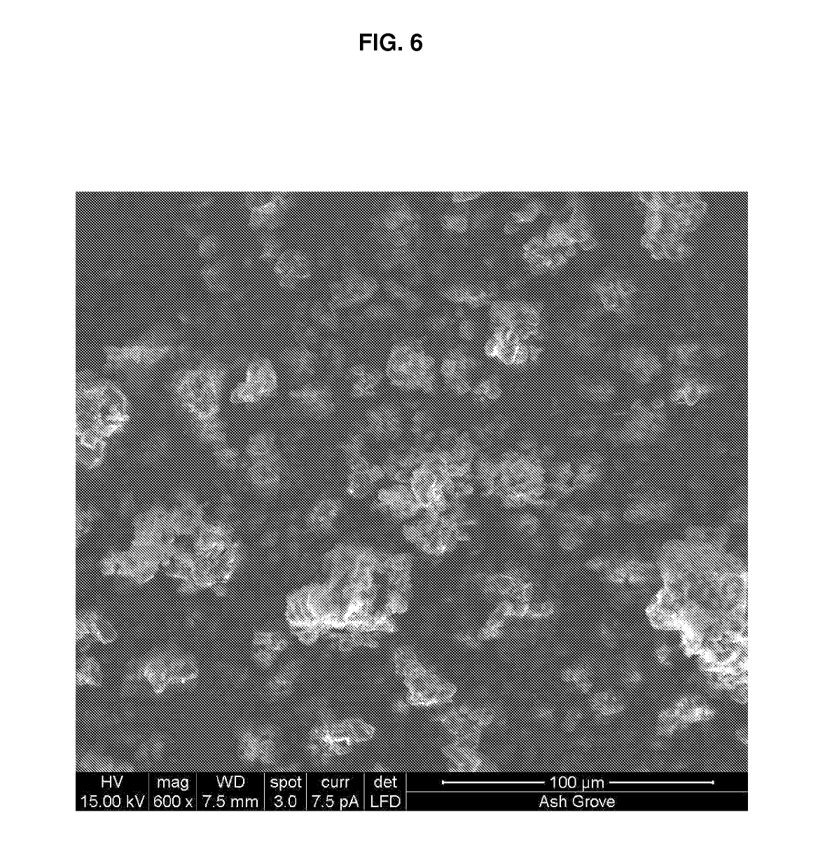

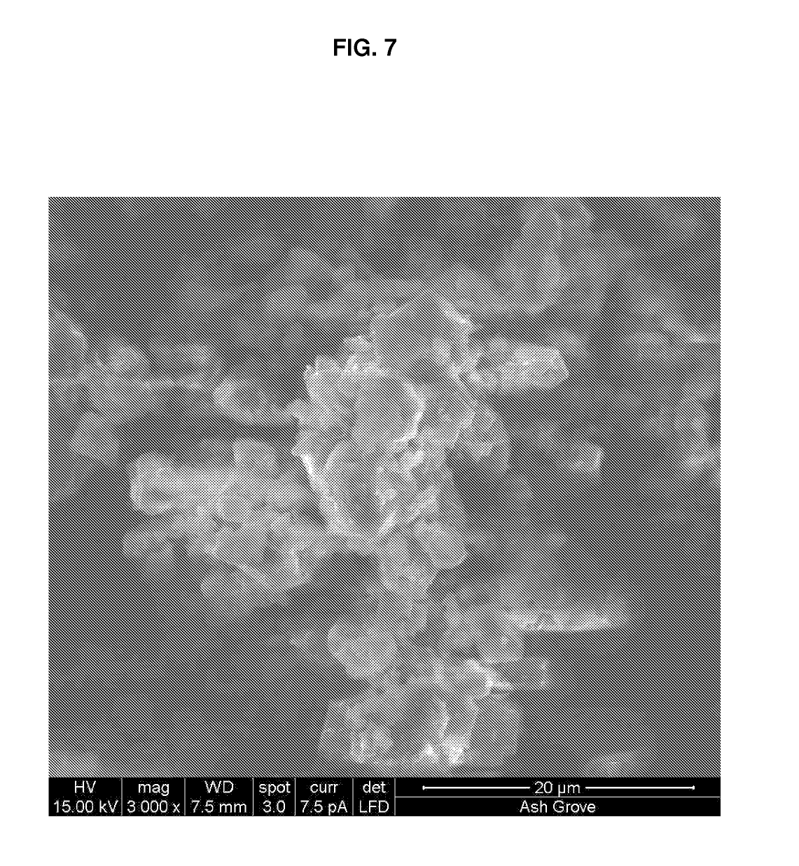

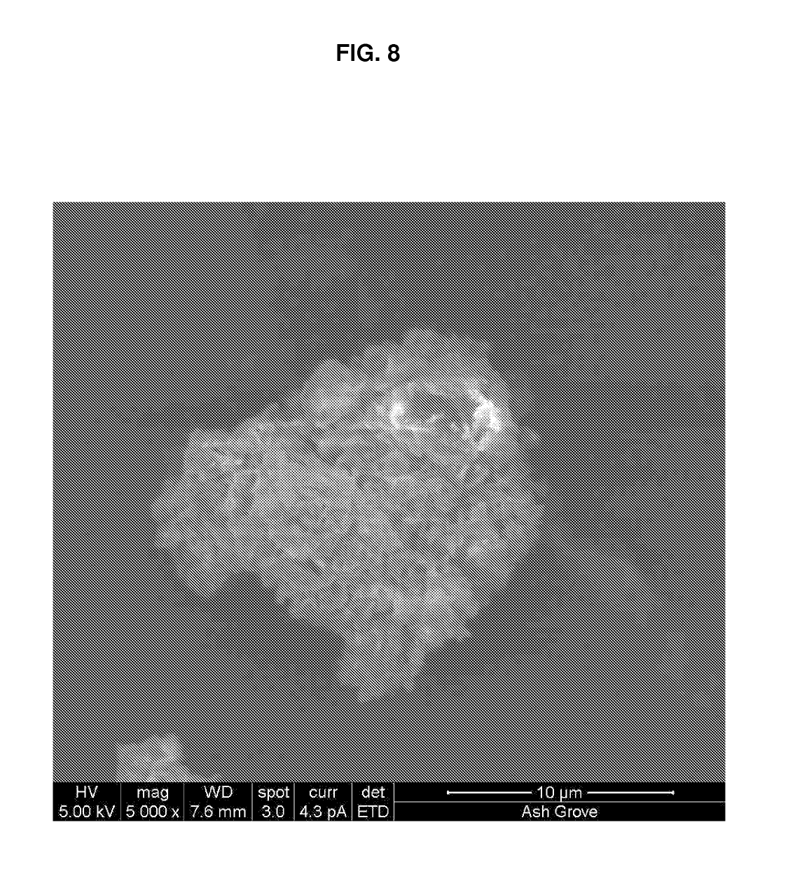

FIGS. 5-8 show scanning electron microscopy micrographs of a sample of solids similar to that of FIG. 10. As shown in FIG. 5 at low magnification of 150×, the sample includes particles having a wide range of sizes and generally porous surfaces. FIG. 6, taken at higher magnification of 600×, shows particle sizes from 10 μm to about 100 μm with the porous surfaces magnified. FIG. 7 shows the sample at high magnification of 3000×, which reveals a generally open structure with flocculated calcium carbonated particles. FIG. 8, taken at still higher magnification of 5000× shows a small, 10 μm particle. Despite its small size, the micrograph shows the particle to be a conglomeration.

The drinking water treatment waste solids may have any suitable particle size. In one aspect, particles of from about 10 μm to about 150 μm were particularly effective in achieving uniform water distribution throughout the cementitious mixture. In another aspect, the particles sizes may be greater than about 150 μm. In another aspect, the particle sizes may be substantially greater than 150 μm.

The solids may have a moisture content of from about 5% to about 55%. In one aspect, the solids have a moisture content of from about 20% to about 40%. In another aspect, the solids have a moisture content of about 35%. In another aspect, the solids have a moisture content of about 5%, or 6%, or 7%, or 8%, or 9%, or 10%, or 15%, or 20%, or 25%, or 30%, or 35%, or 40%, or 45%, or 50%, or 51%, or 52%, or 53%, or 54%, or 55%. The solids may be used with a moisture content as they are collected following flocculation at a water treatment plant, or they may be further dewatered to have a predetermined moisture content. Such further dewatering may be accomplished by any suitable means, for example by centrifugation, pressure filtration, beltpress filtration, vacuum filtration, air drying, thermal drying, and combinations thereof, either at the plant or elsewhere. In order to function as an effective internal curing agent, the solids are not dried and rehydrated. The solids may be stored indefinitely for later use, or they may be collected and used immediately.

In another embodiment the solids may be present in a slurry mixture having a moisture content greater than about 55%. In one aspect, the slurry mixture that includes the solids has a moisture content of from about 55% to about 99%. In one aspect, the slurry mixture has a moisture content of about 55%, or 56%, or 57%, or 58%, or 59%, or 60%, or 61%, or 62%, or 63%, or 64%, or 65% or 70%, or 75%, or 80%, or 85%, or 86%, or 87%, or 88%, or 89%, or 90%, or 91%, or 92%, or 93%, or 94%, or 95%, or 96%, or 97%, or 98%, or 99%. The moisture content of the solid-containing slurry mixture can be adjusted for use in the cementitious product based on the desired end product. The amount of liquid, such as water, that may be required for use in the cementitious product is adjusted dependent on the available moisture in the slurry mixture that contains the solids.

The water treatment waste solids may be collected in dump trucks from a local drinking water treatment plant and delivered to holding bins at a ready-mixed concrete plant. In one aspect, the bins are covered during summer to prevent excessive drying. In the winter, the bins are generally kept from freezing in the same manner that aggregate is commonly kept from freezing so that it can be handled in the winter. Advantageously, the drinking water treatment waste solids do not require the special handling generally required by saturated lightweight aggregate, such as moisture maintenance by sprinkling, or quick use to prevent drying out.

The aggregate includes a mixture of one or more of gravel, crushed rocks or stone, and sand. Other materials, such as slag, recycled concrete, aggregate or glass, geosynthetic aggregates or any other material approved or that may be approved by the American Society for Testing and Materials (ASTM) can also be used.

The cement binder may be any known hydraulic cement capable of hardening because of hydration reactions. Portland cement is the most commonly used cement type because it is a component of concrete, mortar, plaster, stucco and many grouts. ASTM standard C150 recognizes ten types of Portland cement: Type I, Type IA, Type II, Type IIA, Type II (MH), Type II(MH)A, Type III, Type IIIA, Type IV, Type V. In addition, ASTM standard C595 recognizes three classes of blended cement: Type IS(X), Portland blast furnace slag cement, Type IP (X), Portland pozzolan cement, and Type IT(AX)(BV), Ternary blended cement. Some examples of Portland cement blends are Portland fly ash cement, Portland silica fume cement, masonry cements, expansive cements, white blended cements, colored cements and very finely ground cements, although others may also be used. In one aspect, Ordinary Portland Cement (OPC) is employed.

The water treatment waste solids are incorporated into the composition for use as an internal curing agent. Thus, they are used as a low cost replacement for saturated lightweight fine aggregate, the current, most commonly used internal curing agent for Portland cement concrete. Other admixtures may also be incorporated into the concrete mixture. Examples of other admixtures may include colorants, reinforcing fibers, internal curing agents, water conditioners, freeze retardants, or mixtures of these or any other composition known in the art to enhance the appearance or properties of the concrete mixture and/or the concrete end product.

The optimum dosage rate for internal curing agents is based on the chemical shrinkage of the cement, the moisture content of the internal curing agent, and the water-to-cement ratio in the concrete. Bentz et al. have presented an equation for determining the required amount of lightweight aggregate to supply water for internal curing as a function of cement content, expected degree of hydration, chemical shrinkage, and amount of moisture contained in the lightweight aggregates. “Protected Paste Volume in Concrete-Extension to Internal Curing Using Saturated Lightweight Fine Aggregate,” Cement and Concrete Research, Vol. 29, 1999, pp. 1863-1867. This equation is generally used to determine the amount of saturated lightweight aggregate (LWA) that should be included:

$${M}_{LWA} = \frac{{C}_{f} \times CS \times {α}_{max}}{S \times {Φ}_{LWA}}$$

### Where:

M_{LWA}=mass of (dry) fine LWA needed per unit volume of concrete (kg/m³ or lb/yd³)
C_{f}=cement factor (content) for concrete mixture (kg/m³ or lb/yd³)
CS=chemical shrinkage of cement (g of water/g of cement or lb/lb)
αₘₐₓ=maximum expected degree of hydration of cement
S=degree of saturation of aggregate (0 to 1).
Φ_{LWA}=absorption of lightweight aggregate (kg water/kg dry LWA or lb/lb).
It is noted that this equation is valid only for nonzero values of S.

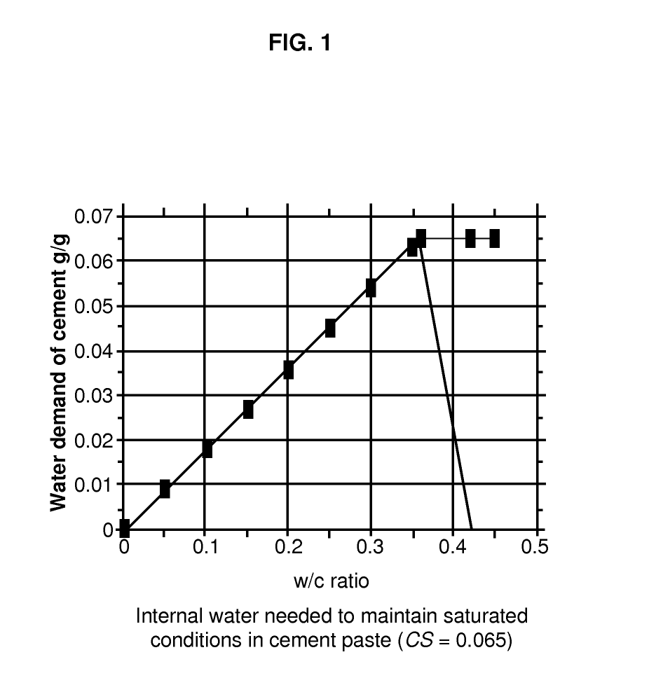

FIG. 1 shows a plot of water to cement ratios against the water demand of cement (in g/g). The data points marked with filled rectangles were determined using the preceding equation of Bentz et al. The unmarked portion of the line graph was developed using the equation of Jenson et al., “Water-Entrained Cement-Based Materials: I. Principle and Theoretical Background,” Cement and Concrete Research, Vol. 31, No. 4, 2001, pp. 647-654; and “Water-entrained Cement-Based Materials: II. Experimental Observations,” Cement and Concrete Research, Vol. 32, No. 6, 2002, pp. 973-978. This demonstrates the internal water needed to maintain saturated conditions in cement paste. By application of these equations, use of drinking water treatment waste solids as an internal curing agent may be used in amounts of up to about 200 lbs. per cubic yard of concrete to achieve optimum saturated conditions in cement paste. In one aspect, the solids may be used as an internal curing agent in amounts of up to about 80 lbs., or 85 lbs., or 90 lbs., or 95 lbs., or 100 lbs., or 105 lbs., or 110 lbs., or 115 lbs., or 120 lbs., or 125 lbs., or 130 lbs., or 135 lbs., or 140 lbs., or 145 lbs., or 150 lbs., or 155 lbs., or 160 lbs., or 165 lbs., or 170 lbs., or 175 lbs., or 180 lbs., or 185 lbs., or 190 lbs., or 195 lbs., or 200 lbs. per cubic yard of concrete It is foreseen that the amount of solids may also be increased from this optimum dosage rate to reduce autogenous shrinkage of the concrete. However, continued increase of the dosage beyond the optimum will eventually result in a decrease in the strength of the concrete product.

The water treatment waste solids, aggregate, cement and water are mixed in accordance with standard practice. In one aspect, a quantity of coarse aggregate is added to a mixer along with a quantity of water and the mixer is actuated. Mixing is continued and fine aggregate is added, followed by cement. The solids may be added with the fine aggregate, or they may be added with the cement. Additional water is added to achieve a predetermined water content or slump prior to curing. The resultant slurry or paste may be formed, using conventional techniques, into any suitable product or structure. Curing is performed in accordance with ASTM C309, Standard Specification for Liquid Membrane-Forming Compounds for Curing Concrete, although it is foreseen that any standard curing protocol may be used.

In another embodiment the water treatment waste solids can be used as an ingredient with any masonry product The masonry products and amount of waste treatment waste solids added will depend on the desired end product. Examples include, but are not limited to, pavers, mortar, brick, cement blocks, grout, plaster, or any product generally categorized as a masonry product.

### Example 1

### Comparative Study of Internal Curing Agents

Different internal curing agents for concrete were studied: pre-wetted light weight fine aggregate (LW), superabsorbent polymer (SAP), and DWTW.

### Materials

The cement used in this study was ordinary Portland cement (OPC) conforming to ASTM C150 Type I. The OPC had a Blaine fineness of 373 m²/kg and an estimated Bogue composition of 55% C₃5, 17% C₂5, 8% C₃A, 10% C₄AF. The DWTW used in the study was light grey in color and had the consistency of damp soil. The material had been dewatered to the as-tested condition and landfilled. The as-received moisture content was 54% on a dry weight basis and specific gravity was 2.41 tested with a helium pycnometer. Chemical composition using x-ray florescence (XRF) showed high calcium content and low contents of silicon, magnesium and aluminum, which is listed in FIG. 9. X-ray diffraction (XRD) showed calcite, quartz and magnetite were the main crystalline components and are shown in FIG. 10. Scanning Electron Microscopy (SEM) showed conglomerations of calcium carbonate platelets ranging from 10 to 100 μm (FIGS. 6, 8). Graded standard sand was used as fine aggregate in the mortars and met requirement for ASTM C 109 and C778. The pre-wetted fine lightweight aggregate was expanded shale from New Market, Mo., had a dry specific gravity of 0.84, density of 47 lb/ft³ (753 kg/m³). The material was vacuum saturated to the tested absorption of 15%. The superabsorbent polymer (SAP) used was partial sodium salt of crosslinked polypromancic acid and had absorption rated at 2000 times in pure water. This SAP has been previously shown to be effective as an internal curing agent. A polycarboxylate high range water reducer was used which met ASTM C494 specification for Type A and Type F admixture.

### Specimen Preparation and Placing

Cement mortar cubes with dimension of 2 in. (50 mm) by 2 in. (50 mm) were used for testing of compressive strength according to ASTM C109, and degree of hydration. Cement mortar beams with dimension of 1 in. (25 mm) by 1 in. (25 mm) by 11¼ in. (285 mm) were used for testing of drying shrinkage and autogenous shrinkage, specified in ASTM C596. For statistical purposes, all of the specimens for the same mixture were investigated as a set of three for cubes and a set of four for shrinkage prisms.

After placing mortars in the molds, they were sealed by covering with plastic bags, and cured at room temperature, 75° F. (23° C.). Specimens were demolded after 24 hours and cured at one of three relative humidities: 25%, 50%, and 100%. Degree of hydration was determined at 7 and 28 days. Degree of hydration was determined using the loss on ignition (LOI) technique outlined by Bentz. Mortar samples were first crushed into fine powder using a mortar and pestle and placed in ceramic crucibles. The non-evaporable water content of each crucible was determined as the mass loss between 212° F. and 1,742° F. (100° C. and 950° C.), LOI of all mixture components was conducted separately beforehand with SAP, LW, and DWTW losses subtracted before determining the final degree of hydration. Compressive strength testing for all the mixtures was conducted at 7 and 28 days. Autogenous shrinkage mortar prisms utilized the same size specimens as total shrinkage, except samples were sealed with wax after demolding at 1 day. Mass change of the autogenous samples was monitored over time to ensure no evaporative losses occurred. The average mass loss of each autogenous shrinkage prism was less than 0.097%.

### Mixture Proportioning

The mortar mixtures were designed with a ratio of cement to fine aggregate of 1:2.5 by weight. The dosage of high range water reducer was 1.5% of cement material for all the mixtures, which is a common dosage for high strength concrete having a water-to-cement ratio of 0.3. The following nomenclature is used in the remainder of this Example: Portland cement control mortar (PC), Portland cement mortar with superabsorbent polymer (SP), Portland cement mortar with pre-wetted lightweight aggregate substituted for a portion of the standard sand (LW), and Portland cement mortar with DWTW substituted for a portion of the standard sand (WT). The mixture proportions are shown in Table 1 below. The numbers following by the alphabetic descriptors represent the amount of additional internal curing water provided by the different agents.

TABLE 1
Mortar mixtures design

| | | SAP | PLWA | DWTW | Internal Curing Water |
|---|---|---|---|---|---|
| Designation | W/C | (%) | (%) | (%) | (water (g)/cement (g)) |
| PC-0 | 0.3 | — | — | — | 0 |
| SP-0 | 0.3 | 0.125 | — | — | 0 |
| SP-0.054 | 0.354 | 0.125 | — | — | 0.054 |
| LW-0.054 | 0.3 | — | 2.38 | — | 0.054 |
| WT-0.054 | 0.3 | — | — | 0.98 | 0.054 |

All percentages by weight

The amount of additional internal curing water selected for comparison across treatments was fixed at 0.054 g water/g cement. The value of 0.054 has been recommended by RILEM as the optimum amount for internal curing with SAP. The optimum dosage of prewetted lightweight aggregates for internal curing is based on the amount of water contained in the aggregate to satisfy chemical shrinkage. While all materials used in this study were dosed to achieve the additional 0.054 g water/g cement, optimum dosage of LW and presumably DWTW using the previously described Bentz equation would require 0.076 g water/g cement. Based on this optimum dosage a roughly 30% increase in internal curing water dosage would be required for the SAP and LW used in this study.

### Results

### Compressive Strength

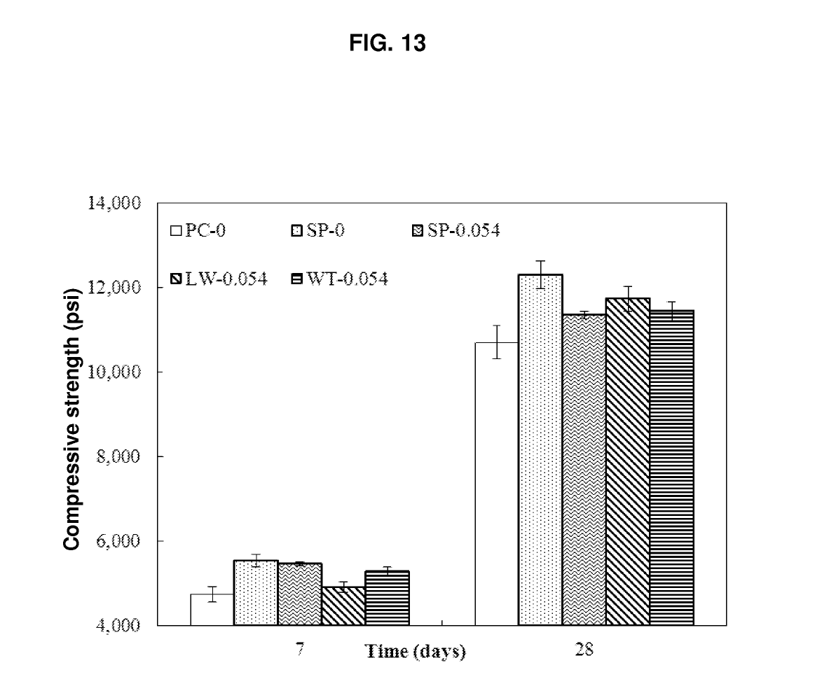

FIG. 13 shows the compressive strength results for the samples cured in lime-water (100% RH). Error bars on the figures represent the coefficient of variance by percentage of the samples. The SAP sample without any additional internal curing water (SP-0) had similar strength to the control. Both the SAP mixture with additional water (SP-0.054) and the lightweight aggregate mixture (LW-0.054) had lower strength than the control. The decreases in strength were expected since the lightweight aggregate is weaker than the standard sand it replaced and, the extra water provided for the SAP results in a correspondingly larger number of voids. What was not expected for the saturated conditions was the increase observed for the mixtures containing DWTW. The mixture WT-0.054 had 8% and 7% increases in compressive strength at 7 and 28 days, respectively.

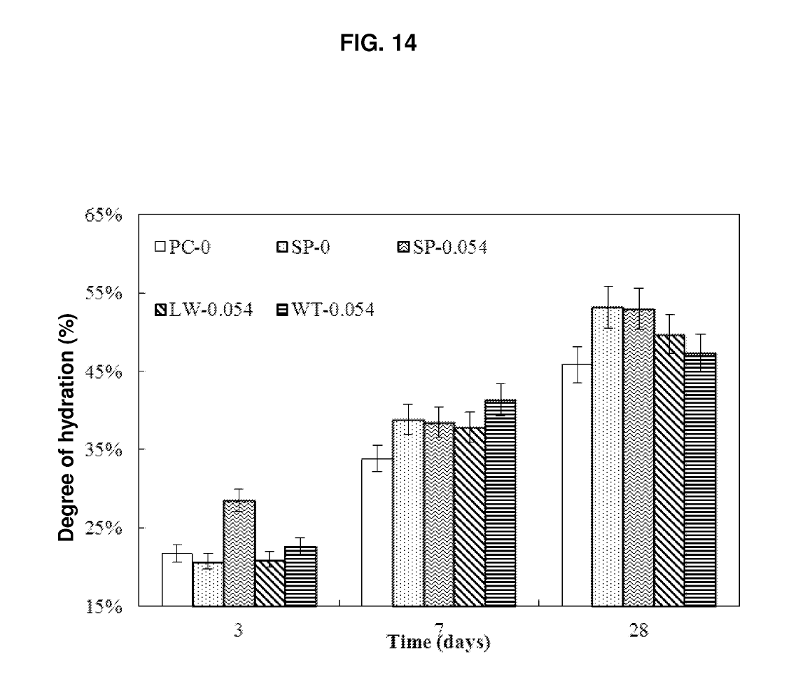

FIG. 14 shows the compressive strength results of the samples cured under sealed conditions. At 7-days the sealed specimens had roughly 50% of the compressive strength of the 100% RH specimens. All of the specimens had significantly higher strength than the control at 7-days except for the lightweight aggregate specimens (LW-0.054). However, at 28-days all of the specimens had significantly higher strength than the control (PC-0). The mixtures with extra internal curing water (SAP-0.054, LW-0.054, and WT-0.054) all had similar strength gain. At 28 days mortar containing SAP without IC water (SP-0) had the highest compressive strength, since SP-0 had effectively the lowest water-to-cement ratio. Overall, using DWTW as alternative internal curing agent showed positive effective on mortar compressive strength, in both curing conditions: 100% RH and sealed condition with similar performance to SAP and LW.

### Degree of Hydration

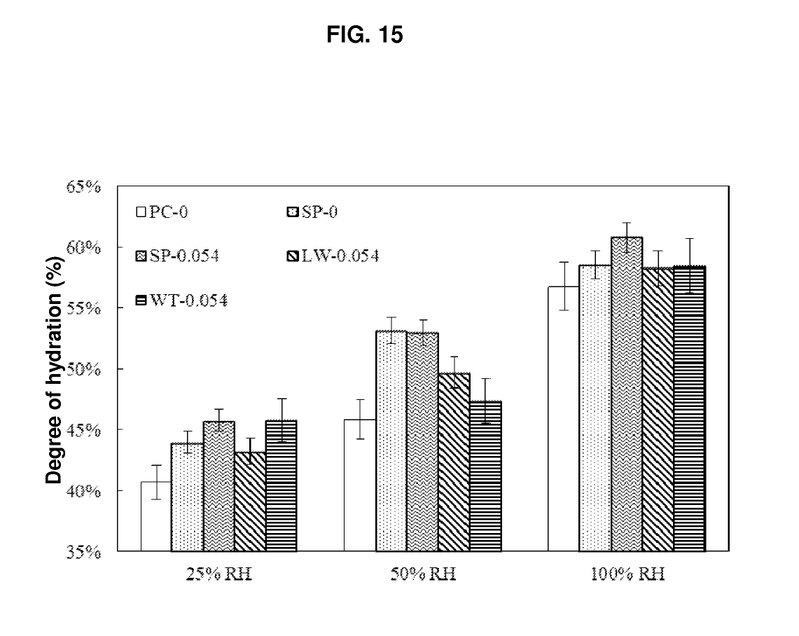

Two factors were evaluated for degree of hydration testing, curing age and curing condition. FIG. 15 shows degree of hydration of mortars cured under 50% relative humidity (RH) at 3, 7 and 28 days. As expected, mortars at later age had higher degrees of hydration. The rate of degree of hydration gain slows from 7 days to 28 days, due to cement hydration process changing into diffusion-controlled reaction. At 3 days, mortar with SAP and with additional IC water (SP-0.054) showed significantly higher degree of hydration (DOH) than all other mortars. There was no statically difference between PC-0 and SP-0, LW-0.054, WT-0.054, with the average DOH around 20%. At 7 days, mortars with internal curing water (SP-0.054, LW-0.054, WT-0.054) and mortar with SAP without IC water (SP-0) showed over a 13% DOH increase compared to the control mortar (PC-0). There was no significant difference between SP-0, SP-0.054 and LW-0.054. However, mortar with DWTW showed the highest DOH rate of all groups, which had 24% DOH increase compared to the control and a 7% DOH increase compared to the other internal curing agents. At 28 days, DOH of all groups reached over 45%. Mortars with SAP with and without IC water (SP-0, SP-0.054) showed the highest DOH with no difference between the two. Mortar with pre-wetted lightweight aggregate (LW-0.054) had second highest DOH and had 4% DOH increase above mortar with DWTW (WT-0.054). LW-0.054 had greatest DOH increase between 7 days and 28 days, followed by WT-0.054.

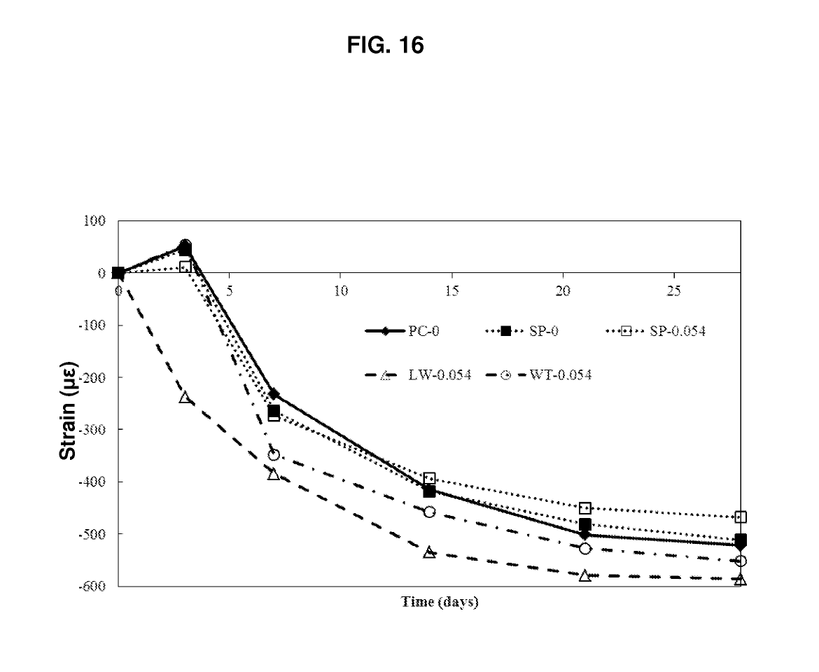

FIG. 16 compares the difference on DOH between curing conditions at 28 days. As expected, the higher the relative humidities (RHs) resulted in higher of degree of hydration. At 25% RH curing condition, mortar with SAP and IC water (SP-0.054) and mortar with DWTW (WT-0.054) showed a significant 12% increase compared to the control mortar (PC-0). There was no difference in DOH between SP-0.054 and WT-0.054. Mortar with SAP without IC water (SP-0) and mortar with pre-wetted lightweight aggregate (LW-0.054) showed similar DOH increase. Mortars cured under 100% RH all achieved over 55% DOH. Mortar containing SAP and IC water (SAP-0.054) showed the highest DOH, around 60%. Mortar with SAP without IC water (SP-0), mortars with internal curing by pre-wetted lightweight aggregate and DWTW (LW-0.054, WT-0.054) showed similar DOH, which had around 3% increase.

Observing the effects of curing time and relative humidity on degree of hydration of all groups, DWTW showed positive effect on early age degree of hydration, and also had significant effect on improving degree of hydration under low relative humidity curing condition, especially when RH dropped under 50%.

### Shrinkage

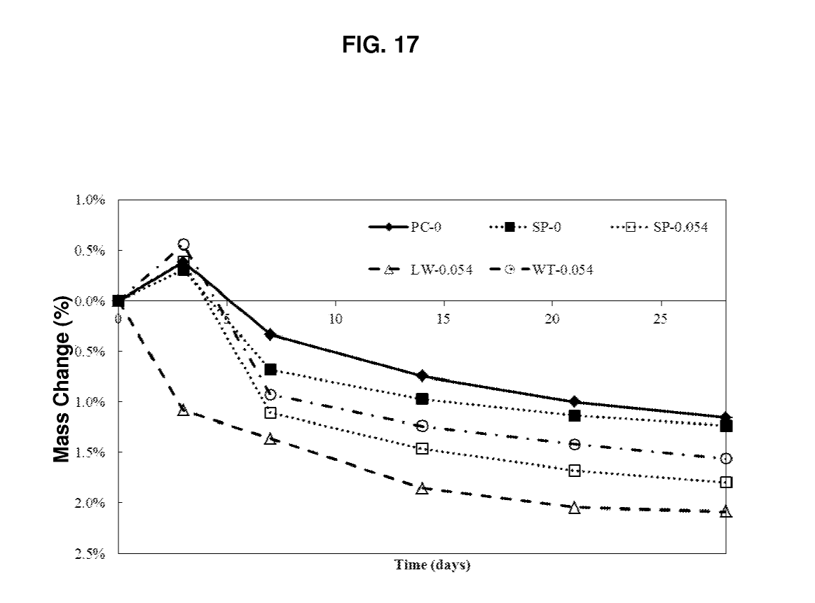

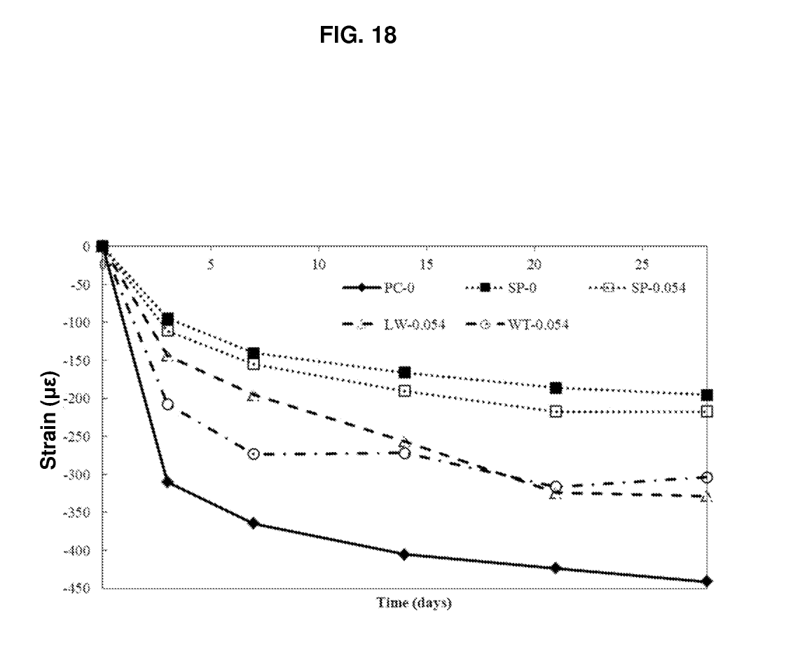

Typically internally-cured concrete has higher moisture loss, with certain moisture contents of pre-wetted lightweight aggregate more prone to high or rapid moisture, as water is both internally through hydration and externally through drying. In FIGS. 17 and 18 mass change and total shrinkage of all groups is shown to 28 days. Mortar with pre-wetted lightweight aggregate (LW-0.054) had the greatest total shrinkage and the greatest mass loss, followed by the DWTW (WT-0.054). Mortar with SAP and additional water (SP-0.054) had the least total shrinkage of all groups however, the second largest mass change. There was no difference in total shrinkage or mass loss between control group (PC-0) and mortar with SAP without IC water (SP-0). The mass loss for DWTW-0.054 was less than other two internal curing groups with the same IC water (SP-0.054, LW-0.054).

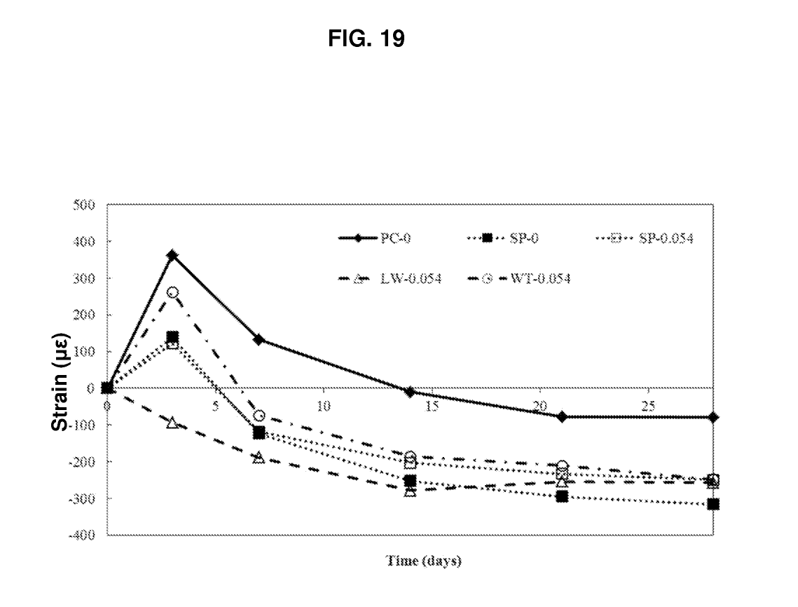

Internal curing water provides compensation for empting the capillary pores in cement paste and also lowers the tensile stresses that develop in the capillary space, reducing self-desiccation shrinkage. Pre-wetted lightweight aggregates and SAPs have been shown to reduce autogenous shrinkage. FIG. 19 shows the comparison of autogenous shrinkage of the mortars. Overall, all of the mortars with internal curing agent had a significant reduction compare to the control group (PC-0). The IC efficiency factor for reducing autogenous shrinkage (η) was defined by Zhutovshy, as being the ratio of the difference of autogenous shrinkage between the reference concrete and the internal cured concrete over the autogenous shrinkage of reference concrete (Δεₐₛ/εₐₛ), at a certain time. At the age of 28 days, among all the groups with same internal curing water, mortar with SAP (SP-0.054) had IC efficiency factor as 0.51, mortar with DWTW (WT-0.054) had IC efficiency factor as 0.31 and mortar with pre-wetted lightweight aggregate (LW-0.054) had IC efficiency factor as 0.26. There was no statistical difference in autogenous shrinkage between mortar with SAP with additional water provided for internal curing (SAP-0.054) and mortar containing SAP without additional water. The results showed DWTW behaves similarly to lightweight aggregate for autogenous shrinkage mitigation.

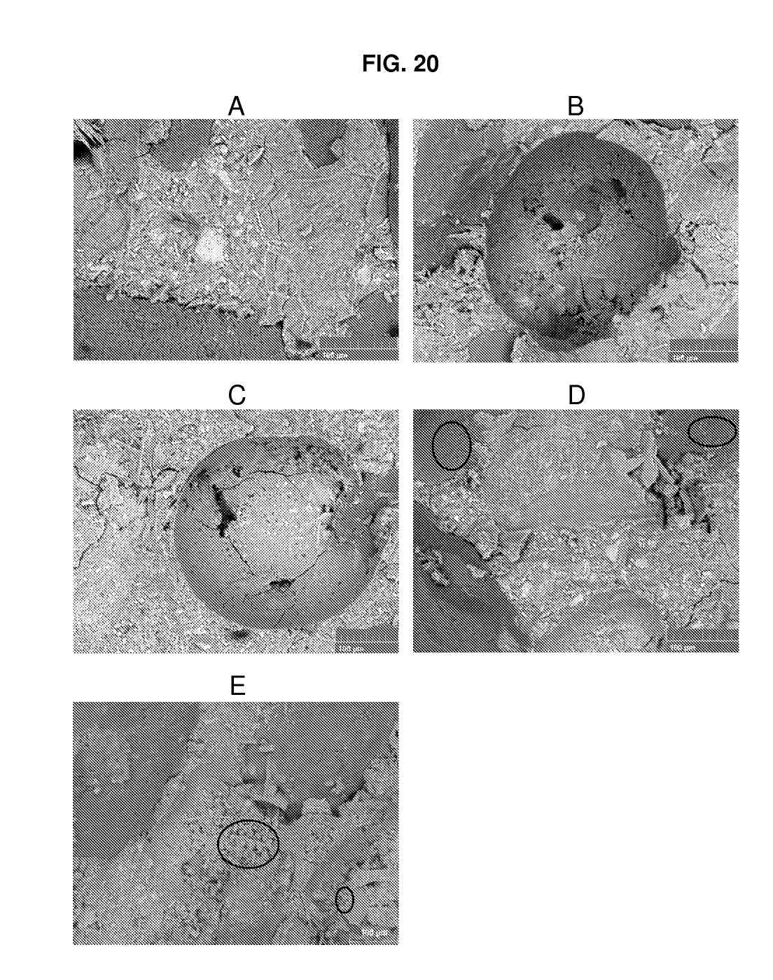

Drying shrinkage was determined as the difference between total (FIG. 17) and autogenous shrinkage (FIG. 19). Results of drying shrinkage are shown in FIG. 20. The control group (PC-0) had the least drying shrinkage. As expected, the internally-cured samples had higher drying shrinkage. However, drying shrinkage was also greater for the SAP mixture which did not contain additional curing water (SAP-0), which was unexpected. At 28-days there was no difference in drying shrinkage between any of the internally-cured samples.

### Scanning Electron Microscopy

Fractured samples from compressive strength testing were examined using the SEM for visual analysis of relative hydration level and interface of the IC materials into the hydration matrix. All the samples were dried at 100° F. (37° C.) for 24 hours prior to imaging. Images shown are from cement mortars cured under sealed conditions and tested at 7 days (shown at FIG. 21). FIG. 21a shows the SEM image of the control group (PC-0). The control sample contained a number of unhydrated cement particles distributed throughout the hardened cement paste, which appeared as bright colored grains. Comparing the SEM images of mortars with SAP with and without internal curing water (FIG. 21(b) and FIG. 21(c)), both images showed the similar sizes of SAP voids, while no large unhydrated cement particles were visible. FIG. 21(d) shows mortar containing lightweight aggregate (LW-0.054) with lightweight aggregate particles highlighted. Mortar with lightweight aggregate showed fewer unhydrated cement particles than the control, especially near the lightweight aggregate particles. Since the dosage rate of lightweight aggregate was low, the area of mortar was internal cured by pre-wetted lightweight aggregate was difficult to distinguish. However, comparing unhydrated cement particles between mortars containing the same IC water dosage, LW-0.054 was not as efficiently cured by IC water as SP-0.054. The SEM image (FIG. 21(e)) of mortar with DWTW (WT-0.054) showed no unhydrated cement particles near the DWTW particles. The chemical composition of the DWTW particles is similar to cement paste making visual identification from SEM contrast also difficult. The particle shown in FIG. 21(e) was identified using energy dispersive spectroscopy (EDS) overlaid on the SEM image. Comparing the water treatment particle shown in FIG. 21(e) with individual DWTW particle shown in FIG. 8, the DWTW particles in the hardened cement paste have a similar structure to the original single particles.

### CONCLUSIONS

DWTW used as an internal curing agent in cement mortar mixture resulted in increased compressive strength at 7 and 28 days. Compared with two other common internal curing agents, superabsorbent polymers (SAP) and pre-wetted lightweight fine aggregate (LW), DWTW showed comparable effect on compressive strength under sealed conditions. When cured at 100% relative humidity (RH), the DWTW samples had the greatest strength of all tested materials.

DWTW provided increased degree of hydration over the control mortar. The improvement on degree of hydration of DWTW was comparable to the two other internal curing agents investigated under a range of curing humidities and ages.

Mortar containing DWTW showed a 25% reduction in autogenous shrinkage, versus the control group at 28 days. Shrinkage reduction was similar to mortar containing pre-wetted lightweight fine aggregate. SAP mortars with and without IC water had the greatest autogenous shrinkage reduction.

DWTW showed similar effect on drying shrinkage as other internal curing agents. Mortars with internal curing agents overall, showed higher drying shrinkage than control group.

Mortar with DWTW showed greater total shrinkage than the control group, but less total shrinkage than mortar with pre-wetted lightweight aggregate. Among the mixtures with the same amount of internal curing water, mortar with DWTW showed less mass loss than mortar with SAP and mortar with pre-wetted lightweight aggregate.

Scanning electron microscope images of all sample under sealed condition showed all mortars containing internal curing agents had fewer unhydrated cement particles than the control.

Drinking water treatment waste is an effective internal curing agent and has similar performance to both the investigated super absorbent polymer and prewetted lightweight fine aggregate. Since drinking water treatment waste is currently a globally available waste product which has a chemical composition similar to cement and contains sufficient moisture for internal curing without additional processing, use of drinking water treatment waste in concrete has the potential to lower the CO₂ footprint and cost, while improving concrete performance.

### Example 2

### Comparative Hydration Studies

Drinking water treatment waste solids from water treatment for Kansas City Mo. were collected following flocculation. After flocculation, the solids content of the drinking water treatment waste is typically from about 8% to about 20%, with a moisture content of from about 80% to about 92% on a dry weight basis. The solids were dewatered by centrifugation to have a moisture content of from about 50% to about 55% on a dry weight basis. The dewatered material was placed into permanent holding excavations. Characterization tests were conducted, including as-sampled moisture content, specific gravity using a helium pycnometer, scanning electron microscopy (SEM) for particle morphology, X-Ray Florescence (XRF) for chemical composition, X-Ray Diffraction (XRD) for crystalline structure, along with degree of hydration testing for internal curing efficacy.

The tested solids were light tan/grey in color and had the consistency of damp soil. The material had a moisture content of 54% on a dry weight basis and a specific gravity of 2.41. Loss on ignition at 900° C. was 40.6%. A variety of particle sizes were present, ranging from about 10 μm to about 100 μm. The morphology showed a conglomeration of platey calcium carbonates. The chemical analysis showed primarily calcium carbonate with smaller amounts of silica and magnesium and other trace elements.

To evaluate the effect of drinking water treatment waste on cement hydration, five different mortar mixtures were evaluated using three curing regimens. The mixtures included one control, two using saturated lightweight shale fine aggregate (SLWA) with absorption of 21% by dry weight, for comparison to the current industry best practice, and two using drinking water waste treatment solids.

### Mixture 1:

A control mortar mixture was prepared without any internal curing agents, using 2.5:1 standard silica sand to cement and a water-to-cement ratio of 0.30 by weight.

### Mixture 2:

A mortar sample was prepared replacing standard sand with SLWA to allow an additional 5 lbs. of water per 100 lbs of Portland cement.

### Mixture 3:

A mortar sample was prepared replacing standard sand drinking water treatment waste solids to allow an additional 5 lbs. of water per 100 lbs. of Portland cement.

### Mixture 4:

A mortar sample was prepared replacing 50% of the volume of standard sand with SLWA.

### Mixture 5:

A mortar sample was prepared replacing 50% of the volume of standard sand with drinking water treatment waste solids

Cube samples measuring 2 inches on all sides were mixed and placed according to ASTM C305. Samples were demolded after 24 hours before individual curing.

Three curing regimes were evaluated for all mixtures. One set of cube samples was cured in a standard lime water bath, representing a best-case scenario for hydration. A second set of cube samples was allowed to cure at 20% relative humidity, representing a worst-case scenario. The third set of cube samples was cured at 50% relative humidity. The temperature for all cases was controlled at 73° F. At predetermined curing ages, material was ground from the face of each sample to a depth of 0.25 inches. Degree of hydration was determined on four samples of each treatment. Reported results represent an average of four specimens. Significance is reported using ANOVA analysis and a=0.05. Degree of hydration was determined by measuring non-evaporable water lost between 100° C. and 900° C. and assuming 0.25 g of water required to fully hydrate 1 g of Portland cement. Loss on ignition of the cement, saturated lightweight shale fine aggregate, and drinking water treatment waste solids were accounted for in determining degree of cement hydration.

### Results

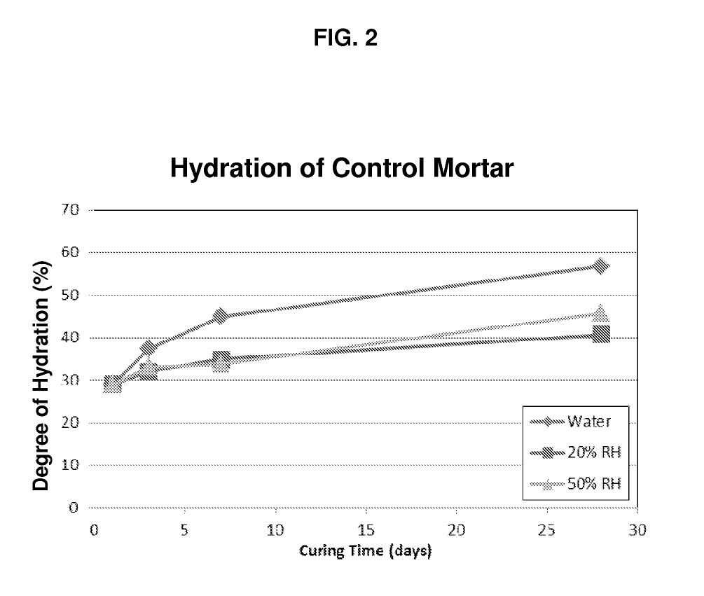

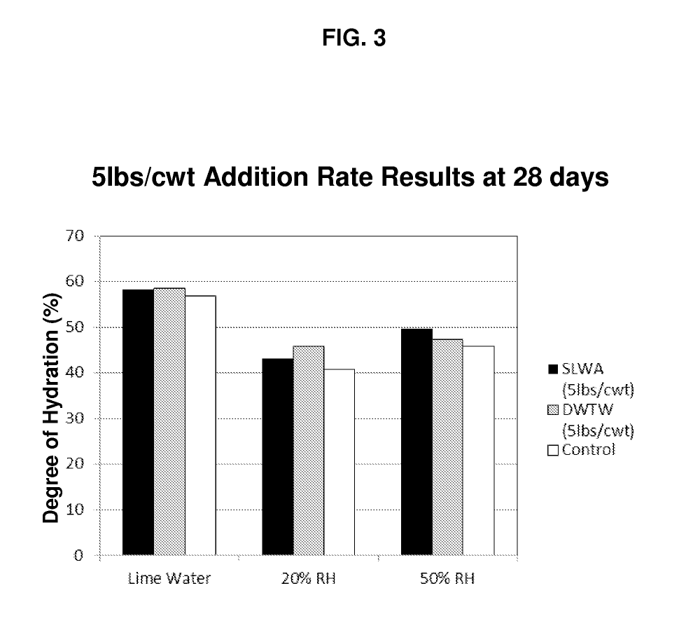

FIG. 2 shows hydration over time of mortar Mixture 1, the control mortar, with no internal curing agents. Results are as expected with the lime water bath providing continued water for hydration. FIG. 3 shows comparative results for mortar Mixtures 1, 2 and 3 after a 28 day cure. There is no significant difference between samples cured in lime water or at 50% relative humidity. At 20% relative humidity there was a significant difference between all treatments. The control obtained 40.7% degree of hydration, while the saturated lightweight shale fine aggregate obtained 43.2% hydration, and the drinking water treatment waste solids obtained 45.8% hydration. This shows that, when standard sand in the mortar mix is replaced with either SLWA or DWTW to allow supplementation with an additional 5 lbs of curing water per 100 pounds of Portland cement, the SLWA mix provides a 6.2% increase in degree of hydration while the DWTW solids mix produces a 12.5% increase in hydration at 28 days.

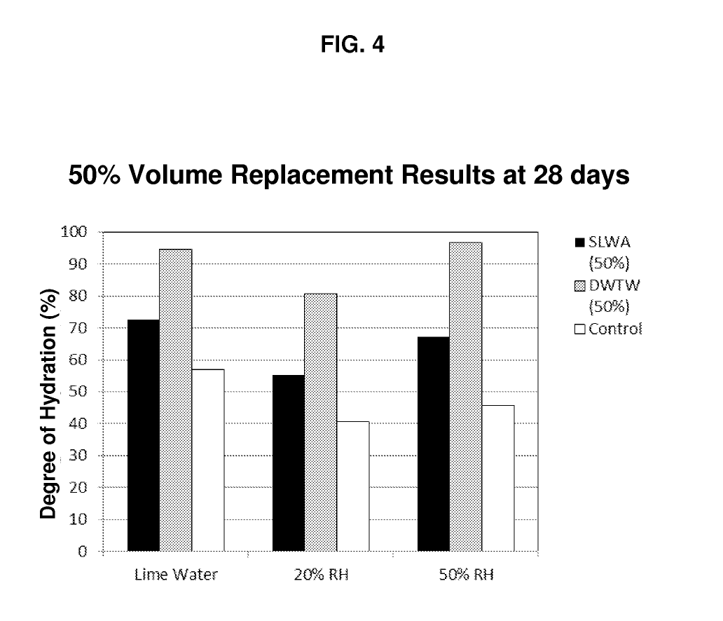

FIG. 4 shows comparative hydration results following a 28 day cure period for Mixtures 1, 4 and 5. The degree of hydration was statistically significant for all mortars across all curing regimes. Replacement of 50% by volume of standard sand with drinking water treatment waste solids provides significantly more water for internal curing (21% for saturated lightweight shale aggregate versus 54% for drinking water treatment waste solids). The results confirm that use of drinking water treatment waste as an internal curing agent provides better hydration. Both the saturated lightweight shale fine aggregate and drinking water treatment waste solids produced similar results when cured at 50% relative humidity and in lime water. The drinking water treatment waste solids produced a 66% increase in hydration versus the control for the lime water cure. The drinking water treatment waste solids produced a 111% increase in hydration versus the control for samples cured at 50% relative humidity and 99% for samples cured at 20% relative humidity.

These results show that drinking water treatment waste solids provide superior hydration as compared with saturated lightweight shale fine aggregate when cured in lime water, at 20% relative humidity and at 50% relative humidity.

### Example 3

### Evaluation of Compressive Strength

Drinking water treatment waste solids were collected and dewatered as in Example 1. Control mortar specimens were produced using standard sand and cement in a ratio of 2.5:1 and a ratio of 0.30 water-to-cement. For workability purposes, 4 oz high-range water reducer was included per 100 lbs of cement. Test samples were prepared replacing 1% by weight of standard sand with drinking water treatment waste solids. The samples were mixed according to ASTM C305 and cured in lime water. Triplicate 2 inch cubes were tested for compressive strength at 7 and 28 days according to ASTM C109. Drying shrinkage was measured according to ASTM C596 using the previously described mixture proportions. Autogenous shrinkage was measured on wax-coated ASTM C596 specimens. Four specimens were tested for drying shrinkage and four specimens were tested for autogenous shrinkage. Samples were stripped after 2 days and placed in lime-water. After 3 days the samples were placed in an environmental cabinet at 73° F. and 50% relative humidity to dry. Moisture loss on the wax-coated specimens was less than 0.2%.

### Results

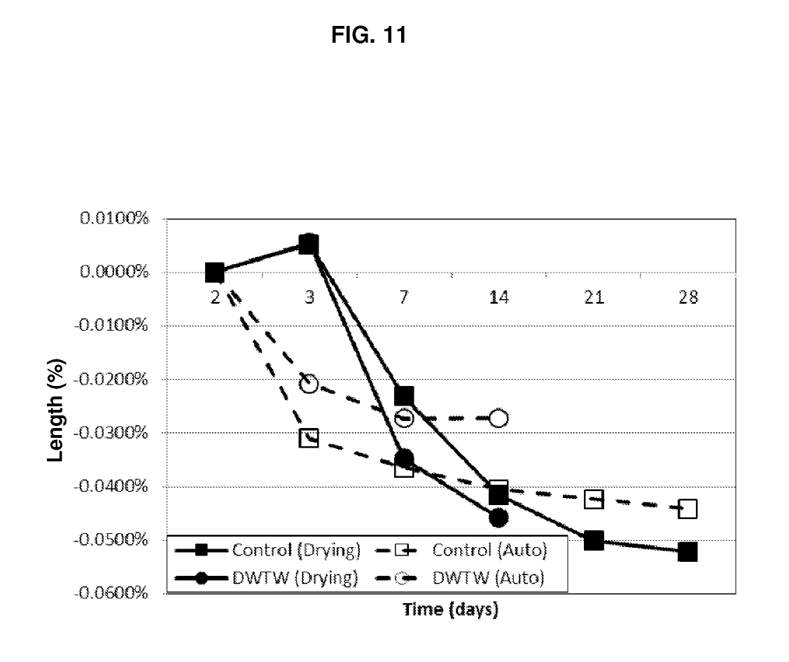

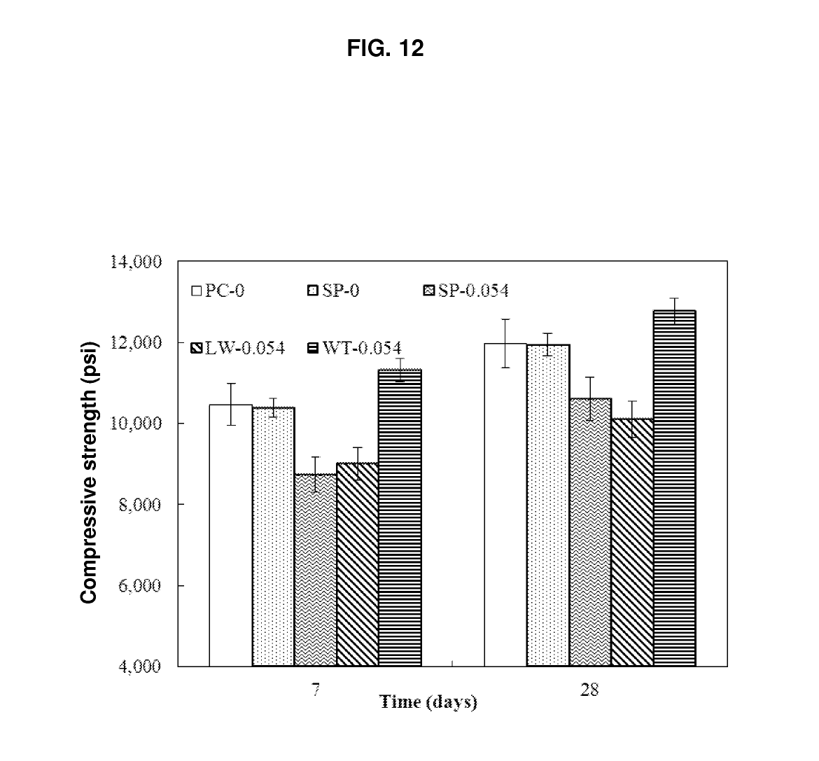

Average compressive strength was measured at 7 days, and was 10,470 psi for the control and 11,310 psi for the drinking water treatment waste solids samples. This represents an 8% increase in average compressive strength. As shown in the FIG. 11, drying shrinkage was similar between the two mixtures. Autogenous shrinkage was significantly less for the drinking water treatment waste solids mixture, which is attributable to the availability of the additional internal curing water in the drinking water treatment waste solids.

These results show that drinking water treatment waste solids impart substantial additional compressive strength with significantly less autogenous skrinkage as compared with standard sand.

It is to be understood that while certain forms of the compositions and methods for internal curing of concrete mixtures and other masonry products have been illustrated and described herein, this disclosure is not to be limited to the specific forms or arrangement of parts described and shown.

1. A cementitious mixture comprising quantities of aggregate, cement, water and drinking water treatment waste solids.

2. The cementitious mixture of claim 1, wherein the drinking water treatment waste solids are produced by a water treatment process comprising the steps of:
a. flocculating a quantity of source water to produce a quantity of floc having entrained water;
b. allowing the floc to settle out from the source water; and
c. dewatering the settled floc to produce a quantity of drinking water treatment waste solids.

3. The cementitious mixture of claim 2 wherein the source water is flocculated using a lime composition.

4. The cementitious mixture of claim 1 wherein:
a. the drinking water treatment waste solids further comprise an internal concrete curing agent; and
b. the drinking water treatment waste solids have a moisture content of from about 5% to about 55%.

5. The cementitious mixture of claim 1 wherein the drinking water treatment waste solids have a moisture content of about 35%.

6. The cementitious mixture of claim 1 wherein the cement is selected from the group consisting of: a Portland cement specified by ASTM standard C150, Portland blast furnace slag cement, Portland-pozzolan cement, Ternary blended cement, Portland fly ash cement, Portland silica fume cement, masonry cement, expansive cement, white blended cement, colored cement, very finely ground cement, and mixtures thereof.

7. The cementitious mixture of claim 6, further including one or more cementitious material selected from the group consisting of fly ash, slag cement, and mixtures thereof.

8. The cementitious mixture of claim 1, further including one or more admixtures selected from the group consisting of colorants, reinforcing fibers, internal curing agents, water conditioners, freeze retardants, and mixtures thereof.

9. The cementitious mixture of claim 1 wherein the drinking water treatment waste solids comprise up to about 200 pounds per cubic yard of the cementitious mixture.

10. The internal curing agent of claim 1, wherein the drinking water treatment waste solids are dewatered by a method selected from the group consisting of flocculation, centrifugation, filtration and air drying, thermal drying and combinations thereof.

11. A method of preparing a cementitious mixture comprising the steps of:
a) providing a quantity of aggregate;
b) providing a quantity of cement;
c) providing a quantity of drinking water treatment waste solids;
d) providing a quantity of water;
e) mixing the aggregate, cement, solids and water to form a cementitious paste; and
f) thereafter allowing the cementitious paste to cure.

12. The method of claim 11, wherein step (c) further includes the steps of:
a. flocculating a quantity of a source water to produce a quantity of floc having entrained water;
b. allowing the floc to settle out from the source water; and
c. dewatering the settled floc to produce a quantity of drinking water treatment waste solids.

13. The method of claim 11 wherein the drinking water treatment waste solids have a moisture content of from about 5% to about 55%.

14. The method of claim 11 wherein the drinking water treatment waste solids have a moisture content of from about 5% to about 99%.

15. The method of claim 13 wherein the drinking water treatment waste solids have a moisture content of about 35%.

16. The method of claim 11 wherein the cement is selected from the group consisting of a Portland cement specified by ASTM standard C150, Portland blast furnace slag cement, Portland-pozzolan cement, Ternary blended cement, Portland fly ash cement, Portland silica fume cement, masonry cement, expansive cement, white blended cement, colored cement, very finely ground cement, and mixtures thereof.

17. The method of claim 11 wherein the drinking water treatment waste solids comprise up to about 200 pounds per cubic yard of the cementitious mixture.

18. A concrete product formed from a cementitious mixture comprising quantities of aggregate, cement, water and drinking water treatment waste solids.

19. (canceled)

20. (canceled)

21. An internal curing agent for use with a cementitious mixture, and comprising drinking water treatment waste sludge.

22. The internal curing agent of claim 21 wherein the drinking water treatment waste sludge is produced by a water treatment process that produces drinking water and a quantity of drinking water treatment waste sludge by:
a. flocculating a quantity of source water to produce a quantity of floc having entrained water,
b. allowing the floc to settle out from the source water,
c. dewatering the settled floc to yield a quantity of drinking water treatment waste sludge.

23. (canceled)

24. The internal curing agent of claim 21, wherein the drinking water treatment waste sludge has a particle size of from about 10 μm to about 150 μm and wherein the drinking water treatment waste sludge has a moisture content of from about 5% to about 55%.

25. (canceled)

26. A structural building element produced by the process of:
a) providing a quantity of aggregate;
b) providing a quantity of cement;
c) providing a quantity of drinking water treatment waste solids having a moisture content of from about 5% to about 55%;
d) providing a quantity of water;
e) mixing the aggregate, cement, solids and water to form a cementitious mixture;
f) the drinking water treatment waste solids comprising up to about 200 pounds per cubic yard of the cementitious mixture; and
f) thereafter allowing the paste to cure.
